(19) United States
(12) Patent Application Publication
(10) Pub. No.: US 2007/0102187 A1
(43) Pub. Date: May 10, 2007

(54) Flexible electrical cable

(75) Inventor: Lothar Kundinger, Fuerth (DE)

Correspondence Address: BIRCH STEWART KOLASCH & BIRCH, PO BOX 747, FALLS CHURCH, VA, 22040-0747, US

(73) Assignee: HEW-Kable/CDT GmbH & Co. KG, Wipperfuerth (DE)

(21) Appl. No.: 11/517,346

(22) Filed: Sep. 8, 2006

(30) Foreign Application Priority Data
Sep. 22, 2005 (DE) 102005045486.0
Aug. 3, 2006 (DE) 102006036621.2

(51) Int. Cl. H01B 9/02

(52) U.S. Cl. 174/105 R

(57) ABSTRACT

A highly flexible, screened electrical line for high-frequency data transmission in swiveling display screens provides that the twisted and/or bundled single wires (1, 2, 3) of the line are held by a taping (6) made of an insulation film coated on one or two sides with aluminum or a tape, that a surrounding wire braid (7) electrically contacts this taping (6) peripherally, that the wire braid (7) is covered by a nonwoven (8), and said nonwoven covering (8) is finally surrounded by an outer sheath (9) of silicone rubber (FIG. 1).

The present invention relates to a highly flexible, shielded electrical line for high-frequency data transmission in swiveling display screens, particularly for swiveling LCD (liquid crystal display) devices

In order to take into account the increasing need for information regardless of the specific location of the interested person, the automotive industry, for example, long since developed display screens which are integrated into a vehicle and with the help of which a very wide variety of data can be displayed, whether information on the status of the vehicle itself, telephone connections, radio programs, or route planning (navigation system), particularly in vehicles for passenger transport. However, it is not always possible, for example, in more compact vehicles, to install the screens necessary for displaying information fixed in space in the vehicle, whether the suitable space requirement is not sufficient or the installation location in the automobile allows only a brief view. In such cases, it is necessary to install the screens swivably in the vehicle so that the screens can be folded up or down, swiveled, turned in any direction, or be pulled out from its storage position or, for example, from a drawer, in order to bring them into a position suitable for the viewer. Accordingly, the mechanical requirements for electrical lines, connected to the screens, for data transmission are high. In a swiveling arrangement of the screen, these lines are pulled, stretched, and twisted, limits being rapidly established for the electrical line for pulling, stretching, and twisting without damage, when the ambient temperatures assume very low or high values. Thus, it turned out that, e.g., in areas with permafrost, conventional data lines are not suitable to assure the functioning of the screen. The data lines, becoming stiff at low temperatures, for example, permit neither a folding out nor turning of the screen, and undisturbed data information is no longer possible.

The object of the present invention, therefore, is to propose a data line for the described swiveling screens, which assures the functioning of the screens with undisturbed data receipt as independent as possible from the predominating ambient temperatures.

This object is achieved according to the invention in that the twisted and/or bundled electrical conductors are held by a taping made of an insulation film coated on one or two sides with aluminum or a coated tape, that a surrounding wire braid contacts this taping peripherally, that the wire braid is covered by a nonwoven, and said nonwoven covering is finally surrounded by an outer sheath of silicone rubber. A variant of the invention is that instead of the nonwoven for covering the wire braid, a wrapping of a stretched and sintered polytetrafluoroethylene film is used for the same purpose. This construction of an electrical data line in both variants assures the swiveling of a screen in any direction even under permafrost conditions with simultaneous undisturbed data transmission. A screen connected with a line according to the invention can accordingly be folded forward or backward, turned in one or another direction, or pulled in the direction of the viewer, or moved away again by said viewer without impairing the transmission quality for the specific data.

An aluminum-coated film can, for example, also be a polyester film or another plastic film, but it is especially advantageous in carrying out the invention to use an aluminum-coated tape of a nonwoven material. The flexibility of the data line is substantially improved in this manner also at extremely low temperatures.

Depending on the requirements during the data transmission, the taping according to the invention can surround two mutually twisted single wires or also at least two pairs consisting of two twisted wires. Therefore, for example, 2, 4, 8, or also 10 pairs can be arranged under the taping.

An especially advantageous embodiment of the invention arises, however, when the taping surrounds two mutually twisted single wires and the insulation of the single wires consists of a wrapping of the conductor with a stretched and sintered tape or a film of a non-melt-processable fluoropolymer. This fluoropolymer is usually a polytetrafluoroethylene, whereby the term polytetrafluoroethylene also comprises tetrafluoroethylene polymers that are provided with modifying additives, but in such an amount that the polymers, such as polytetrafluoroethylene itself, is non-melt-processable. This embodiment of the invention not only exhibits high flexibility with dynamic installation over a broad temperature range between −50° C. and +180° C. but is also easily suitable for a transmission frequency above 600 MHz and at a shielding effectiveness greater than 65 dB. A further improvement of this data line results when in a continuation of the invention the PTFE (polytetrafluoroethylene) wrapping of the conductor carries a layer of melt-processable fluoropolymer connected frictionally at least with the topmost tape or film layer. Because the ratio of the wall thicknesses of the tape or film wrapping to the frictionally connected layer in carrying out the invention is 3:1, this layer is to be regarded merely as a skin layer covering the wrapping. For example, the tetrafluoro-ethylene/hexafluoropropylene copolymer (FEP), the perfluoroalkoxy polymer (PFA), or also the tetrafluoroethylene/perfluoroalkyl vinyl ether copolymer (TFA/PFA) has proven suitable for this skin layer. But other known melt-processable fluoropolymers as well can at times find advantageous application.

Suitable filling strands, i.e., particularly those that have little static friction to the surface of the single wires, are advantageously arranged in the strand interstices of the two mutually twisted single wires.

An especially advantageous embodiment of the invention results, however, when in the strand interstices of the two single wires provided for data transmission, additional wires are arranged for the current supply. This type of current supply is required, for example, by the adjusting motors at swiveling displays or the drive motors for mirror adjustments in or on vehicles. The electrical conductors, carrying the feeding current, of these wires expediently have an insulation of a melt-processable fluoropolymer.

If the single wires or pairs are twisted around a central filling strand, the so-called central member, then it has proven especially advantageous in a continuation of the invention to produce the filling strand of a stretched and sintered shaped strand of polytetrafluoroethylene (PTFE). The shaped strand consists advantageously of a PTFE tape twisted into a strand. The advantages of such a shaped strand is its low-temperature flexibility and the absence of material wear, which, as in the case of glass silk central members, easily leads to contamination of the electronic components in the swiveling LCD devices.

If, as set forth above, 2, 4, 8, or 10 pairs are held by the taping of the invention, then to increase the flexibility and transmission properties of the data line it proved advantageous to twist the individual pairs with a different lay length.

The broad temperature range during use of the data line according to the invention demands a suitable sheath material. Here, it proved advantageous to carry out the invention, if the outer sheath is made of a hot-vulcanized silicone rubber, a so-called HTV silicone rubber. Another advantageous option is to choose an LSR (liquid silicone rubber) rubber as the sheath material.

The invention will be described in greater detail with use of the data lines shown as exemplary embodiments in FIGS. 1 to 3. The electrical lines described here are suitable for the low-voltage/high-speed data transmission over copper wires (LVDS) because of their special properties.

FIG. 1 shows a one-pair screened, highly flexible data line for an EMV-optimized transmission of data (LVDS interface) with extremely high reverse bending ability over a broad temperature range, as can be used advantageously particularly in automotive technology for the connection of swiveling screens. Hereby, copper conductor 1 with a diameter of, e.g., 0.50 mm is insulated with a wrapping 2 of a stretched and sintered tape or a suitable film of polytetrafluoroethylene (PTFE), which is known under the trade name HEI-tape® from the applicant. Wrapping 2 of the PTFE tape carries a skin layer 3 of a melt-processable fluoropolymer, for example, of a tetrafluoroethylene/hexafluoropropylene copolymer (FEP) Filling strands 4 in the interstices of the twisted single wires serve to stabilize the twisted assembly; they can also be made of a suitable plastic, but can also consist of glass fibers. Twisted assembly 5 having the aforementioned individual elements is surrounded by the taping 6 of an aluminum-coated nonwoven. A shield braid, consisting of tinned copper wires, is designated with the number 7; it is covered by the taping 8 of a nonwoven, which can also be replaced by a stretched and sintered polytetrafluoroethylene tape. The outer casing of the data line of the invention is formed by sheath 9 of a hot-vulcanized (HTV) silicone rubber. The outside diameter of this data line, constructed according to the invention, is about 4.5 mm, and the operating voltage according to its use in automotive technology 48 V.

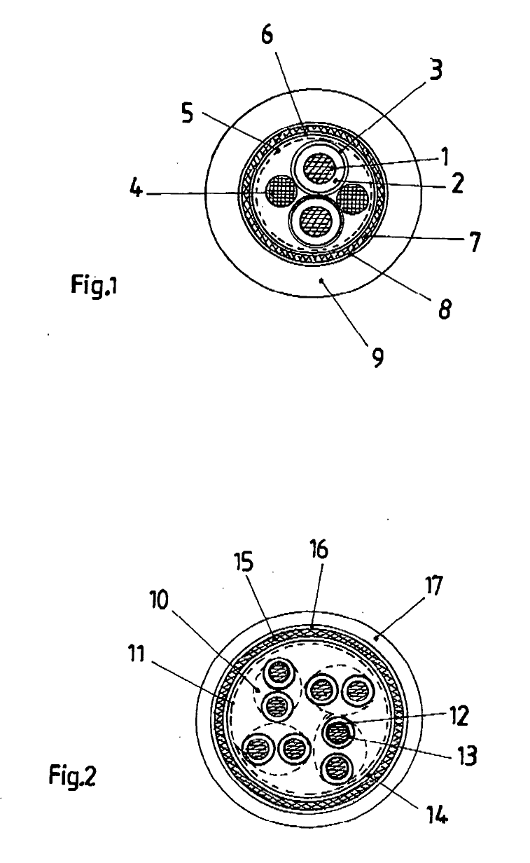

According to the requirements for such data lines, an embodiment of the invention according to FIG. 2 may also be used. In this data line, four pairs 10 are combined into a twisted assembly 11. Electrical conductor 12 of pairs 10 with an outside diameter of, e.g., 0.6 mm in this embodiment consists of bare, tinned, or silvered copper wires. Insulation 13 of conductor 12 consists of a melt-processable aforementioned fluoropolymer, for example, of an FEP. Taping 14 surrounding all four pairs can consist of a film wrapping of an aluminized polyester tape, but according to the exemplary embodiment of FIG. 1, an aluminum-coated fiber fleece can also assume the task of the taping with a simultaneous shielding action. Braid 15, which consists of tinned or silvered copper wires and is in turn surrounding by taping 16 of a nonwoven material, is used for further shielding of the data line. The data line of the invention is sealed outwardly by sheath 17, for example, of an HTV silicone rubber or an LSR rubber.

The silicone rubber sheath, which remains consistently flexible at low temperatures as well, here in connection with the described components of the data line also assures its high reverse bending ability, which allows a dynamic type of installation in swiveling screens or screens that can be pulled out of drawers or covers. In this embodiment of the electrical line, the outside diameter is about 6.0 to 6.5 mm, and the operating voltage is also 48 V.

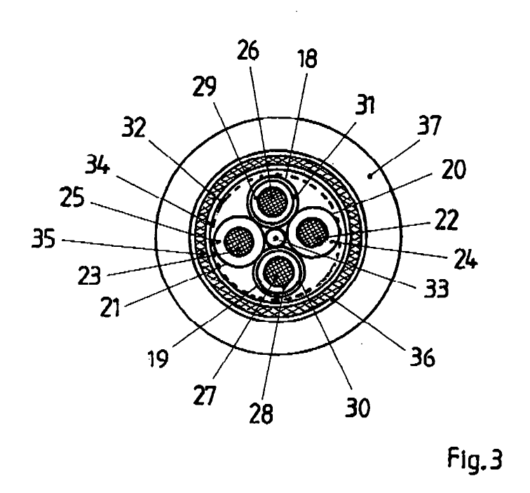

In keeping with FIG. 1, FIG. 3 shows an especially advantageous embodiment of the invention, in which in the strand interstices of the two single wires 18 and 19 provided for data transmission, additional wires 20 and 21 are disposed, which are used for the current supply, e.g., for adjusting motors in swiveling screens, Because these wires are not used for data transmission, their electrical conductors 22 and 23 are provided only with insulation 24 or 25 of a melt-processable fluoropolymer, for example, of an FEP.

For data transmission, however, it is a matter of an insulation with a low dielectric constant, e.g., on the order of 1.3 F/m. For this reason, conductors 26 and 27 of single wires 18 and 19 are first insulated with a wrapping 28 or 29 of a stretched and sintered tape or of a suitable polytetrafluoroethylene film. These tape or film wrappings are each covered by insulation layers 30 and 31 of a meltable fluoropolymer, in the shown exemplary embodiment of the aforementioned FEP.

Filling strand (central member) 33 is disposed in the center of twisted assembly 32 formed of wires 18, 19, 20, and 21. To increase the flexibility of this line at extremely low temperatures as well, for example, up to −50° C., it consists of a stretched and sintered PTFE tape, twisted into a strand. The use of this material has the advantage, apart from the high low-temperature flexibility of the filling strain of the invention, that contamination by material wear due to movements, to be performed during operation of the line, by the connected swiveling devices is avoided.

Twisted assembly 32 having the aforementioned wires is surrounded by taping 34 of an aluminum-coated nonwoven. The nonwoven is covered by shield braid 35, e.g., of tinned copper wires. Moreover, a taping 36 of a nonwoven tape is disposed, whereby it is possible if so desired to replace this nonwoven tape by a stretched and sintered PTFE tape. The outer casing of this line of the invention is formed by sheath 37 of a silicone rubber. The outside diameter of this data line according to the invention is about 4.8 mm, and the operating voltage according to its use in automotive technology is 48 V The special advantage of the line is the problem-free use in a temperature range of about −50° C. to +135° C.

1. Highly flexible, screened electrical line for high-frequency data transmission in swiveling display screens, particular for swiveling LCD (liquid crystal display) devices, wherein the twisted and/or bundled electrical conductors are held by a taping made of an insulation film coated on one or two sides with aluminum or a coated tape, a surrounding wire braid electrically contacts this taping peripherally, the wire braid is covered by a nonwoven, and said nonwoven covering is finally surrounded by an outer sheath of silicone rubber.

2. Highly flexible, screened electrical line for high-frequency data transmission in swiveling display screens, particular for swiveling LCD (liquid crystal display) devices, wherein the twisted and/or bundled electrical conductors are held by a taping made of an insulation film coated on one or two sides with aluminum or a coated tape, a surrounding wire braid electrically contacts this taping peripherally, the wire braid is covered by a wrapping of a stretched and sintered polytetrafluoroethylene film, and said wrapping is finally surrounded by an outer sheath of silicone rubber.

3. Electrical line according to claim 1, wherein the aluminum-coated tape is a tape of nonwoven material.

4. Electrical line according to claim 1, wherein the taping surrounds two mutually twisted single wires.

5. Electrical line according to claim 1, wherein the taping surrounds at least two pairs consisting of two twisted wires.

6. Electrical line according to claim 4 having two twisted single wires, wherein suitable filling strands are disposed in the strand interstices of the two single wires.

7. Electrical line according to claim 4, wherein the insulation of the single wires consists of a wrapping of the conductor with a stretched and sintered tape or a film of a non-melt-processable fluoropolymer.

8. Electrical line according to claim 7, wherein the non-melt-processable fluoropolymer is a polytetrafluoroethylene.

9. Electrical line according to claim 7, wherein the wrapping of the conductor carries a layer of melt-processable fluoropolymer connected frictionally at least with the topmost tape or film layers.

10. Electrical line according to claim 4 having two twisted single wires, wherein additional wires for current supply are disposed in the strand interstices of the two single wires provided for data transmission.

11. Electrical line according to claim 10, wherein the insulation of the two additional wires consists of a melt-processable fluoropolymer.

12. Electrical line according to claim 1 having a central filling strand (central member), around which the single wires or pairs are twisted, wherein the filling strand consists of a stretched and sintered shaped strand of polytetrafluoroethylene.

13. Electrical line according to claim 12, wherein the stretched and sintered shaped strand consists of a polytetrafluoroethylene tape twisted into a strand.

14. Electrical line according to claim 7, wherein the ratio of the wall thicknesses of the tape or film wrapping to the frictionally connected layer is about 3:1.

15. Electrical line according to claim 5, wherein the insulation of the wires, twisted into pairs, consists of a melt-processable fluoropolymer.

16. Electrical line according to claim 15, wherein the individual pairs are twisted with a different lay length.

17. Electrical line according to claim 1, wherein the outer sheath of the line is a hot-vulcanized (HTV) silicone rubber.

18. Electrical line according to claim 1, wherein the outer sheath of the line is an LSR (liquid silicone rubber) rubber.

19. Electrical line according to claim 3, wherein the single-pair screened line in the dynamic state has a high flexibility at temperatures of −50° C. to +180° C. at a transmission frequency >600 MHz.

20. Use of the electrical line according to claim 1 for the low-voltage/high-speed data transmission over copper wires (LVDS).
